(19) United States
(12) Patent Application Publication
(10) Pub. No.: US 2026/0355569 A1
(43) Pub. Date: Nov. 12, 2026

(54) STAIR CLIMBER

(71) Applicant: Bancoresy Technology (ZheJiang) Co., Ltd, Ningbo (CN)

(72) Inventors: Zhiqiang Zheng, Ningjin County (CN); Jian Li, Ningjin County (CN)

(21) Appl. No.: 19/722,613

(22) Filed: Jun. 26, 2026

(30) Foreign Application Priority Data
Dec. 24, 2025 (CN) 202522731749.X

(51) Int. Cl. H02K 7/18; A63B 22/04; F16H 37/06; H02K 7/10; H02K 7/116

(52) U.S. Cl. CPC H02K 7/1853; A63B 22/04; F16H 37/065; H02K 7/1004; H02K 7/116

(57) ABSTRACT

A stair climber is provided, including a support frame and a generator. The support frame is provided with an inclined frame, the inclined frame houses an end gear assembly, the end gear assembly is fitted with a looped chain, foldable steps are secured to the looped chain, and the end gear assembly is connected to the generator. During operation, the stair climber requires no external power supply; instead, it generates its own electricity to power the system. This design is energy-efficient, environmentally friendly, and operates stably, providing a comfortable climbing experience.

### TECHNICAL FIELD

The present disclosure relates to the field of fitness equipment, and specifically to a stair climber.

### BACKGROUND

Stair climbers are a common type of cardio equipment found in gyms and are primarily used for fitness training.

By using these stair climbers to simulate continuous stair climbing, you can quickly raise your heart rate and burn fat efficiently, while significantly toning your glutes and hamstrings. Compared to a treadmill, the stair climber puts less strain on knees and ankles. Current high-end commercial models also feature touchscreens and virtual mountain climbing applications to make workouts more enjoyable.

To enhance intelligence of these stair climbers, they are currently equipped with magnetic resistors to adjust operating resistance. When a user applies force with their legs while walking upward, the rotational speed can be adjusted via the magnetic resistance. However, since the magnetic resistance setting remains constant regardless of a user's weight, existing stair climbers cannot adjust the rotational speed based on an individual body weight. Consequently, manual adjustments are required, resulting in a low level of automation. Furthermore, existing stair climbers of this type require an external power supply during operation, as the entire unit must be powered by an external power supply.

Given the shortcomings of the prior art, the technical challenges that need to be addressed by those skilled in the art are: 1. designing a stair climber that can automatically adjust its speed based on a user's weight; and 2. achieving self-power generation without the need for an external power source.

### SUMMARY

To overcome the shortcomings of the prior art, the present application discloses a stair climber that incorporates a generator. When a person stands on the machine, the rotating stairs drive the generator to produce electricity, and the power generated internally powers the entire system.

To achieve the aforementioned technical objective, the present disclosure specifically employs the following specific solution:

The stair climber designed in the present disclosure includes a support frame and a generator. The support frame is provided with an inclined frame, the inclined frame houses an end gear assembly, the end gear assembly is fitted with a looped chain, foldable steps are secured to the looped chain, and the end gear assembly is directly or indirectly connected to the generator; the foldable steps drive movement of the looped chain with stepping motions, thereby causing the end gear assembly to operate, and during operation, the end gear assembly drives the generator to operate.

According to the preceding stair climber, it further includes a transmission pulley assembly. The end gear assembly includes two primary shafts and two gears, the two gears are spaced apart from each other, the two gears are rotatably mounted on the inclined frame via their respective primary shafts, the looped chain is sleeved on the two gears and meshes with them, and any one of the gears is drivingly connected to the generator via the transmission pulley assembly.

According to the preceding stair climber, the transmission pulley assembly includes a first transmission pulley, a second transmission pulley, a third transmission pulley, a fourth transmission pulley, a fifth transmission pulley, and a sixth transmission pulley; the first transmission pulley is secured to one of the primary shafts, and a first gear on the primary shaft is coaxially arranged with the first transmission pulley; the second transmission pulley and the third transmission pulley are both rotatably mounted on the inclined frame via a secondary shaft, and the first transmission pulley is drivingly connected to the second transmission pulley via a first transmission belt; the generator is mounted on the inclined frame via a mounting frame; the fourth transmission pulley and the fifth transmission pulley are both rotatably mounted on the mounting frame via a tertiary shaft, and the third transmission pulley is drivingly connected to the fourth transmission pulley via a second transmission belt; the sixth transmission pulley is fixedly sleeved on a main shaft of the generator, and the fifth transmission pulley is drivingly connected to the sixth transmission pulley via a third transmission belt.

According to the preceding stair climber, a first tensioner pulley is correspondingly provided on an outer side of the second transmission belt.

According to the preceding stair climber, a support rod is mounted on the inclined frame, the support rod is located adjacent to the second transmission belt, a traction plate is rotatably mounted on an upper end of the support rod, a fixing rod is secured to a lower end of the support rod, a traction spring is secured to the fixing rod, an upper end of the traction spring is secured to an end of the traction plate, and the first tensioner pulley is rotatably mounted at the center of the traction plate.

According to the preceding stair climber, a second tensioner pulley is correspondingly provided on an outer side of the third transmission belt.

According to the preceding stair climber, two end gear assemblies are provided, the inclined frame is formed with a tread space and a mounting space located on opposite sides of the tread space, and the two end gear assemblies are arranged in parallel and respectively located within the respective mounting spaces; the foldable steps are located within the tread space, and two gears of each of the end gear assembly are respectively located at the top and bottom of the mounting space.

According to the preceding stair climber, the inclined frame includes two spaced-apart inclined frame bodies, the tread space is formed between the two inclined frame bodies, and the mounting space is formed within the inclined frame bodies; an inclined beam is secured within each of the inclined frame bodies, and the inclined beam is arranged along the longitudinal direction of the inclined frame body; both ends of the two primary shafts are mounted on the two inclined beams via first bearing housings, respectively, and the secondary shaft is mounted on one of the inclined beams adjacent to the first transmission belt via a second bearing housing; an outer guard plate and an inner guard plate are mounted on an outer side and an inner side of each of the inclined frame bodies, respectively, each inner guard plate is formed with an elongated opening through which an inner portion of the looped chain extends, and the inner portions of each of the looped chains are respectively hinged to the opposite sides of the foldable steps.

According to the preceding stair climber, the two inclined beams are connected by a plurality of intermediate crossbeams, the plurality of intermediate crossbeams are located within the tread space, the foldable steps are arranged around the plurality of intermediate crossbeams, and the mounting frame is secured to one of the intermediate crossbeams.

According to the preceding stair climber, the foldable steps include a plurality of treads, the plurality of treads are arranged in a circular pattern along the looped chain and are hinged to one another, and an angle between any two adjacent treads is an obtuse angle or an acute angle.

According to the preceding stair climber, a power supply and a control module are provided inside the stair climber, and a driver and a pulse width modulator are provided inside the control module.

According to the preceding stair climber, a control panel is provided at an upper part of the stair climber, a support column is secured to the top of the inclined frame, and the control panel is secured to the support column.

According to the preceding stair climber, handrails are provided on sides of the stair climber, and a handle and a control panel are provided on the top of the handrail.

According to the preceding stair climber, the bottom of the support frame is provided with casters, and support feet are provided on the sides of the casters.

According to the preceding stair climber, a frame of the caster is provided with threaded holes, and a fixing column of the support foot is threadedly connected to the threaded hole.

According to the preceding stair climber, the generator is a variable impedance motor.

The beneficial effects of the present disclosure are as follows: The stair climber of the present disclosure rotates the foldable steps through treading, causing the staircase to rotate; the rotating staircase drives a looped chain, which in turn drives a generator to produce electricity; by adjusting the impedance, a constant output speed is maintained. This design enables a constant output speed for users of varying body weights. When different climbing speeds with different frequencies are set, the stair climber maintains a constant output speed solely through internal automatic impedance adjustment. The entire unit requires no external power supply, relying solely on self-generated electricity to power the system. It is energy-efficient, environmentally friendly, and operates stably, providing a comfortable climbing experience. It overcomes various technical problems in existing technologies and is an ideal self-powered stair climber.

### BRIEF DESCRIPTION OF DRAWINGS

FIG. 1 is a diagram illustrating a three-dimensional structure of the present disclosure;

FIG. 2 is a diagram I illustrating an interior structure of the present disclosure from a side view;

FIG. 3 is a diagram I illustrating an interior three-dimensional structure of the present disclosure;

FIG. 4 is a diagram II illustrating an interior three-dimensional structure of the present disclosure;

FIG. 5 is a diagram III illustrating an interior three-dimensional structure of the present disclosure;

FIG. 6 is a partial enlarged view in FIG. 5;

FIG. 7 is a diagram II illustrating an interior structure of the present disclosure from a side view; and

FIG. 8 is a diagram illustrating a structure of an electric control unit of the present disclosure.

Reference numerals: 1. Support frame; 10. Intermediate crossbeam; 2. Inclined frame; 20. Outer guard plate; 21. Inclined beam; 22. End gear assembly; 221. Primary shaft; 222. First bearing housing; 23. Gear; 24. Looped chain; 25. Mounting bracket; 26. Inner guard plate; 261. Elongated opening; 27. Inclined frame body; 28. Tread space; 29. Mounting space; 30. Enclosure plate; 3. Transmission pulley assembly; 31. First transmission pulley; 32, Second transmission pulley; 33. Third transmission pulley; 331. Secondary shaft; 332. Second bearing housing; 34. Fourth transmission pulley; 35. Fifth transmission pulley; 351. Tertiary shaft; 36. Sixth transmission pulley; 37. First transmission belt; 38. Second transmission belt; 39. Third transmission belt; 4. Generator; 40. Mounting frame; 41. First tensioner pulley; 411. Support rod; 412. Traction plate; 413. Traction spring; 414. Fixing rod; 42. Second tensioner pulley; 43. Power supply; 44. Control module; 5. Handrail; 51. Handle; 52. Cup holder; 6. Support column; 61. Control panel; 7. Foldable step; 71. Tread; 8. Caster; 81. Threaded hole; 9. Support foot; 91. Spacer; 92. Fixing column; 441. Driver; 442. Pulse width modulator.

### DETAILED DESCRIPTION OF THE EMBODIMENTS

The present disclosure is described in detail below with reference to specific embodiments; however, it should be noted that the specific embodiments described herein do not impose any technical limitations on the technical solution. Those skilled in the art may make further technical extensions based on the technical solutions described below.

### Embodiment

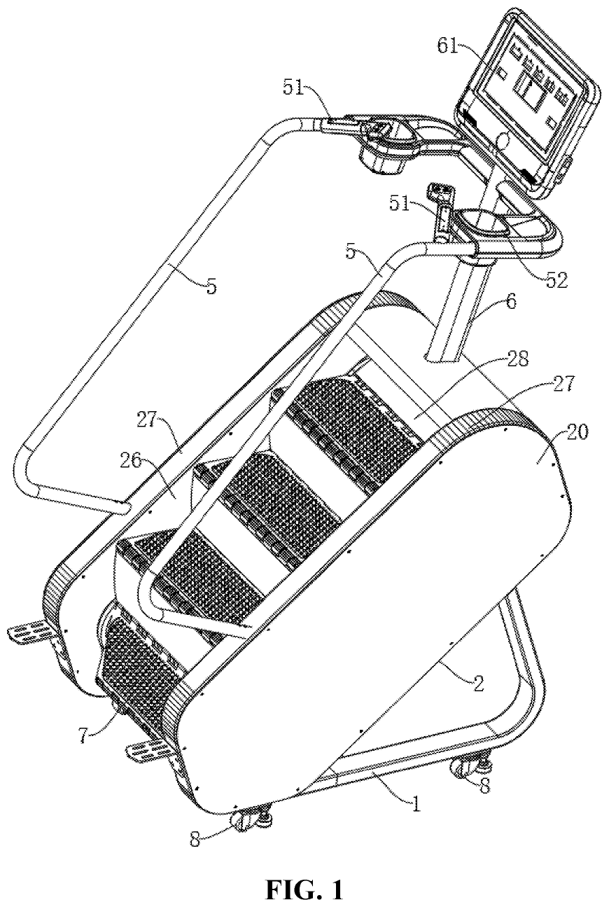

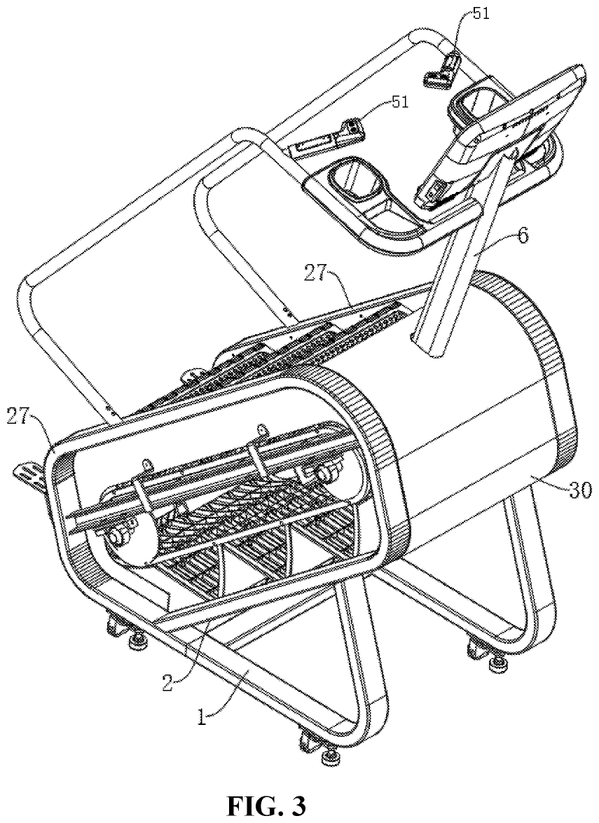

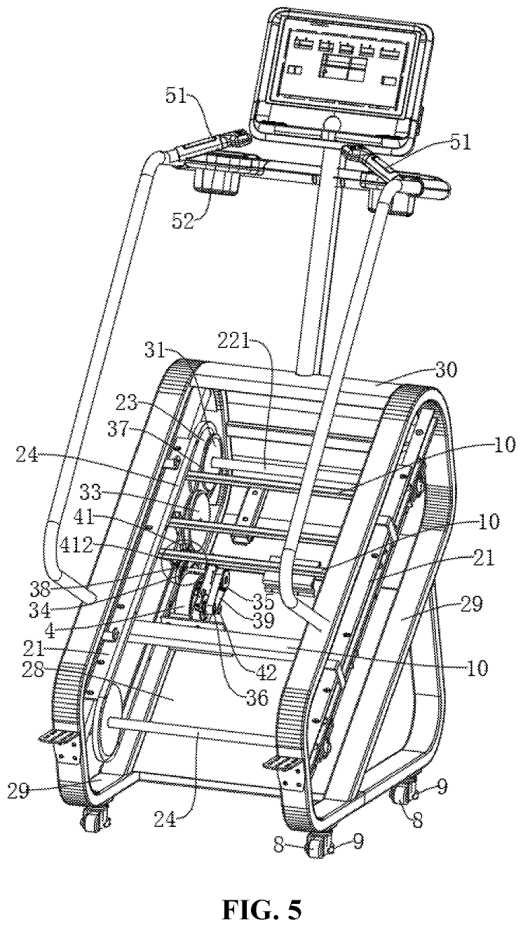

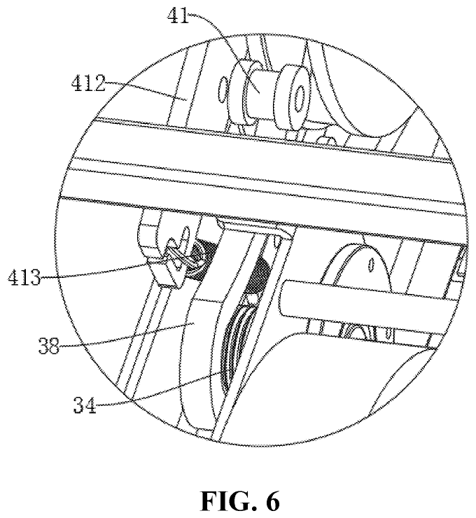

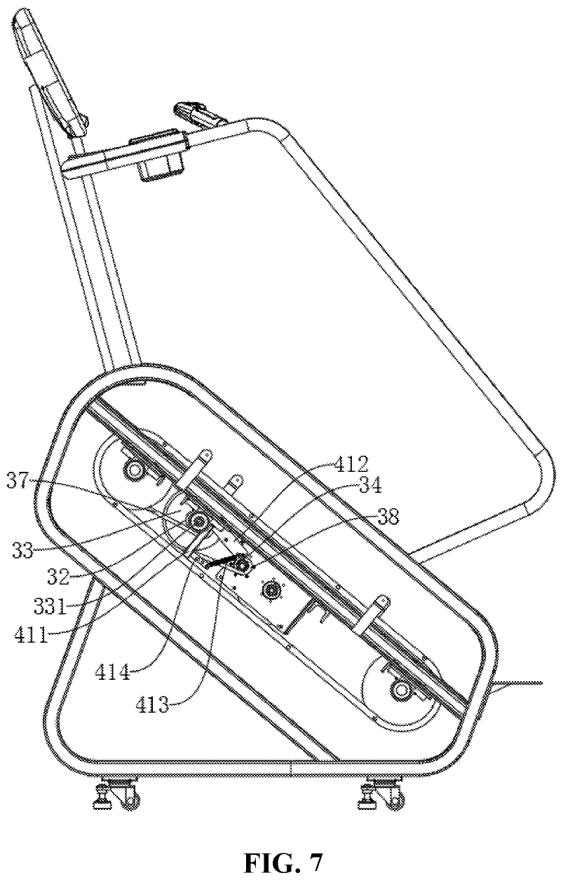

As shown in FIGS. 1-7, the stair climber described in this embodiment includes a support frame 1, with a caster 8 mounted at either the front or rear end of the bottom of the support frame 1, and a support foot 9 positioned adjacent to the caster 8; among them, a threaded hole 81 is provided on the frame of the caster 8, and a fixing column 92 of the support foot 9 is threadedly connected to the threaded hole 81; therefore, when movement is required, rotating the support foot 9 causes the fixing column 92 of the support foot 9 to engage with the threaded hole 81, lifting a spacer 91 of the support foot 9 off the ground, thereby allowing the stair climber to be moved via the casters 8; once moved to a desired position, rotating the support foot 9 causes the fixing column 92 of the support foot 9 to engage with the threaded hole 81, causing the spacer 91 of the support foot 9 to contact the ground, thereby securing the stair climber in place. The casters 8 are swivel casters, and there is a gap between the caster 8 and the support foot 9.

The support frame 1 is provided with an inclined frame 2. An end gear assembly 22 is secured inside the inclined frame 2 via an inclined beam 21, and the end gear assembly 22 is configured to mount the looped chain 24. Foldable steps 7 are secured to the looped chain 24, and the end gear assembly 22 is directly or indirectly connected to the generator. When a person steps on the foldable step 7, the foldable step 7 drives the looped chain 24 in a circular motion, causing the end gear assembly 22 to operate, and during operation, the end gear assembly 22 drives the generator to operate. In particular, to improve operational stability and reduce maintenance frequency, the generator 4 in this embodiment is a brushless generator. Furthermore, the brushless generator used is a variable impedance motor, which maintains a constant output speed by adjusting its impedance. In this embodiment, a transmission pulley assembly 3 is further provided. The end gear assembly 22 includes two primary shafts 221 and two gears 23, the two gears 23 are spaced apart from each other, the two gears 23 are rotatably mounted on the inclined frame 2 via their respective primary shafts 221, the looped chain 24 is sleeved on the two gears 23 and meshes with them, and any one of the gears 23 is drivingly connected to the generator 4 via the transmission pulley assembly 3. Its structure allows the power generated by stepping on the foldable steps 7 to be transmitted smoothly to the generator, resulting in a well-engineered structure that operates reliably and enhances performance.

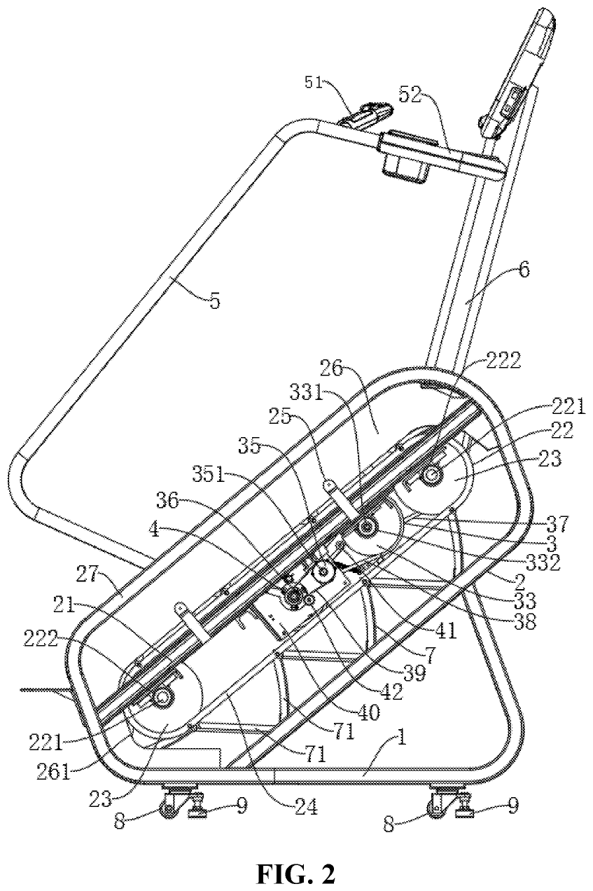

Specifically, as shown in FIGS. 2, 4, and 5-7, the transmission pulley assembly 3 includes a first transmission pulley 31, a second transmission pulley 32, a third transmission pulley 33, a fourth transmission pulley 34, a fifth transmission pulley 35, and a sixth transmission pulley 36; the first transmission pulley 31 is secured to one of the primary shafts 221, and a first gear 23 on the primary shaft 221 is coaxially arranged with the first transmission pulley 31; the second transmission pulley 32 and the third transmission pulley 33 are both rotatably mounted on the inclined frame 2 via a secondary shaft 331, and the first transmission pulley 31 is drivingly connected to the second transmission pulley 32 via a first transmission belt 37; the generator 4 is mounted on the inclined frame 2 via a mounting frame 40; the fourth transmission pulley 34 and the fifth transmission pulley 35 are both rotatably mounted on the mounting frame 40 via a tertiary shaft 351, and the third transmission pulley 33 is drivingly connected to the fourth transmission pulley 34 via a second transmission belt 38; the sixth transmission pulley 36 is fixedly sleeved on a main shaft of the generator 4, and the fifth transmission pulley 35 is drivingly connected to the sixth transmission pulley 36 via a third transmission belt 39. In this configuration, an outer diameter of the first transmission pulley 31 is smaller than that of the adjacent gear 23, an outer diameter of the second transmission pulley 32 is smaller than that of the first transmission pulley 31, an outer diameter of the third transmission pulley 33 is larger than that of the fourth transmission pulley 34, the outer diameter of the fourth transmission pulley 34 is smaller than that of the fifth transmission pulley 35, and the outer diameter of the fifth transmission pulley 35 is larger than that of the sixth transmission pulley 36. Consequently, the structural design of the transmission pulley assembly 3 ensures reliable power transmission, thereby further improving the generator's power generation efficiency. The preceding transmission pulleys are respectively driven by a synchronous belt transmission method or a multi-V belt transmission method, or the transmission pulley can be replaced by a sprocket and each transmission belt can be replaced by a chain.

Preferably, a first tensioner pulley 41 is correspondingly provided on an outer side of the second transmission belt 38, and a second tensioner pulley 42 is correspondingly provided on an outer side of the third transmission belt 39; the second tensioner pulley 42 is rotatably mounted on the mounting frame 40 via a rotary shaft, the first tensioner pulley 41 and the second tensioner pulley 42 are preferably pulleys, and when the transmission pulley is in a chain drive, it can be replaced with a sprocket. Among them, the arrangement of the first tensioner pulley 41 and the second tensioner pulley 42 prevents the second transmission belt 38 and the third transmission belt 39 from becoming slack during operation. This ensures that the power generated by stepping on the foldable step 7 is transmitted more smoothly and reliably to the generator during a stair climber's operation. At the same time, these components serve to tension the drive system, thereby enhancing operational reliability and stability and further improving the generator's power generation efficiency.

More preferably, to ensure that the first tensioner pulley 41 is mounted properly and reliably so as to provide elastic tension and compress the second transmission belt 38, a support rod 411 is mounted on the inclined frame 2, the support rod 411 is located adjacent to the second transmission belt 38, a traction plate 412 is rotatably mounted on an upper end of the support rod 411, a fixing rod 414 is secured to a lower end of the support rod 411, a traction spring 413 is secured to the fixing rod 414, an upper end of the traction spring 413 is secured to an end of the traction plate 412, and the first tensioner pulley 41 is rotatably mounted at the center of the traction plate 412.

In this embodiment, two end gear assemblies 22 are provided, the inclined frame 2 is formed with a tread space 28 and a mounting space 29 located on opposite sides of the tread space 28, and the two end gear assemblies 22 are arranged in parallel and respectively located within the respective mounting spaces 29; the foldable steps 7 are located within the tread space 28, and two gears 23 of each of the end gear assembly 22 are respectively located at the top and bottom of the mounting space 29. This structural layout is reasonably designed, allowing users to step in the middle while transmitting power to both sides of the tread space 28, thereby ensuring smooth power transmission during stepping and providing a relatively stable stepping experience.

Specifically, as shown in FIGS. 1 and 2, the inclined frame 2 includes two spaced-apart inclined frame bodies 27, the tread space 28 is formed between the two inclined frame bodies 27, and the mounting space 29 is formed within the inclined frame bodies 27; an upper opening of the tread space 28 is open to allow a user to enter and step onto the foldable step 7, while a lower opening and a top opening of the tread space 28 are closed by an enclosure plate 30, and the enclosure plate 30 is secured to the inclined frame body 27; an inclined beam 21 is secured within each of the inclined frame bodies 27, and the inclined beam 21 is arranged along the longitudinal direction of the inclined frame body 27; both ends of the two primary shafts 221 are mounted on the two inclined beams 21 via first bearing housings 222, respectively, and the secondary shaft 331 is mounted on one of the inclined beams 21 adjacent to the first transmission belt 37 via a second bearing housing 332; an outer guard plate 20 and an inner guard plate 26 are mounted on an outer side and an inner side of each of the inclined frame bodies 27, respectively, each inner guard plate 26 is formed with an elongated opening 261 through which an inner portion of the looped chain 24 extends, and the inner portions of each of the looped chains 24 are respectively hinged to the opposite sides of the foldable steps 7. In particular, the provision of the inner guard plate 26 prevents the user's feet from entering the mounting space 29 while stepping on the foldable step 7, and the provision of the outer guard plate 20 seals off the entire outer side of the inclined frame body 27, thereby enhancing the aesthetic appearance. Furthermore, the inner guard plate 26 is fixedly connected to the inclined beam 21 via a mounting bracket 25, thereby securing the inner guard plate 26 to an inner side of the inclined frame body 27.

Preferably, the two inclined beams 21 are connected by a plurality of intermediate crossbeams 10, the plurality of intermediate crossbeams 10 are located within the tread space 28, the foldable steps 7 are arranged around the plurality of intermediate crossbeams 10, and the mounting frame 40 is secured to one of the intermediate crossbeams 10. Its structural design makes the inclined frame 2 relatively sturdy and reliable.

More preferably, the foldable steps 7 include a plurality of treads 71, the plurality of treads 71 are arranged in a circular pattern along the looped chain 24 and are hinged to one another, and an angle between any two adjacent treads 71 is an obtuse angle or an acute angle, with end side surfaces of any two adjacent treads 71 being hinged to an inner portion of the looped chain 24.

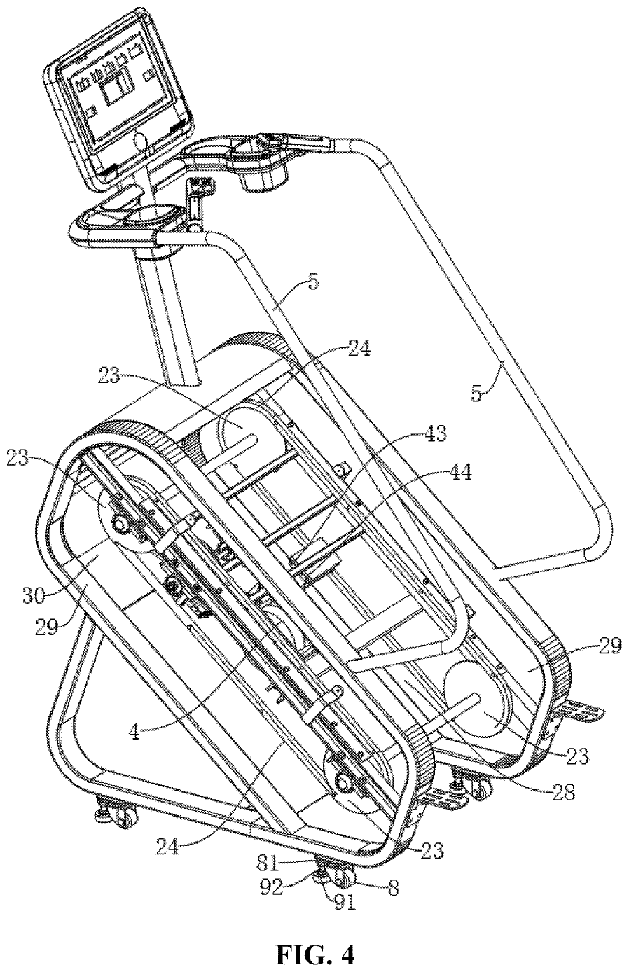

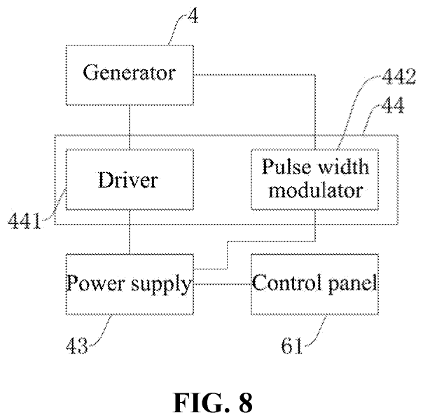

Another key design feature of the present disclosure is that a power supply 43 and a control module 44 are arranged within the stair climber. A driver 441 and a pulse width modulator 442 are provided inside the control module 44. The generator 4 is electrically connected to the power supply 43 via the driver 441. When a user walks on the foldable steps 7, the looped chain 24 is driven to rotate the generator 4 under the force of gravity to generate electricity. The generated current passes through the driver 441 for rectification and inversion before being fed into the power supply 43. The rotational speed of the generator 4 is ultimately adjusted by modifying impedance via the pulse width modulator 442. A control panel 61 is mounted on an upper part of the stair climber. An output terminal of the power supply 43 is electrically connected to the control panel 61, and the power supply 43 discharges to provide electricity to the entire operating system and the control panel 61. The preceding power supply 43 is typically designed as a compact power supply 43 that provides electricity temporarily only during startup; during training, power is supplied directly from the generator 4. The user can adjust the speed of the stairs on the control panel 61; the corresponding data corresponds to speeds of the brushless generator. This speed adjustment is achieved through a pulse width modulator. Once these data are configured, whether a user weighing 50 kilograms walks on the foldable step 7 or a user weighing 250 kilograms walks on the foldable step 7, the rotational speed of the generator 4 can be effectively maintained at a constant level. This means the rotational speed of the foldable step 7 remains constant, thereby effectively maintaining the user's step frequency and achieving stable training results. Please also refer to FIGS. 4, 5, and 8.

Preferably, the power supply 43 and the control module 44 are bolted to an intermediate crossbeam 10 and are surrounded by the foldable steps 7.

Furthermore, the present disclosure also includes handrails 5 fixedly mounted on the upper side surfaces of both inclined frame bodies 27 of the stair climber. A support column 6 is secured to the top of the inclined frame 2, and a control panel 61 is secured to the top of the support column 6. The upper ends of the two handrails 5 are respectively secured to opposite sides of the support column 6, in which the handrails 5 are configured to provide lateral protection to the user during training.

When the handrail 5 is secured to the support column 6, plug posts are secured to the opposite sides of the support column 6. Since the handrail 5 is in a tubular structure, the plug posts are inserted into an upper end of the handrail 5 to secure the handrail 5 with the support column 6.

A cup holder 52 and a handle 51 are further mounted on the upper end of the handrail 5. The cup holder 52 can hold a cup, while the handle 51 provides hand support during the user's workout, making the exercise more convenient.

In summary, the present disclosure maintains a constant rotational speed of the brushless generator 4 by adjusting its impedance. This design enables a constant output for users of varying body weights. When different stair-climbing speeds are set, a constant output is achieved solely through internal automatic impedance adjustment; the entire unit generates electrical energy by driving the generator through the operation of foldable steps, which is then supplied via the power supply 43 to power the control panel and operating system. Therefore, no external power supply is required, enabling self-generation to support the system's power needs. This achieves the technical benefits of energy efficiency, environmental friendliness, stable operation, and a comfortable stair-climbing experience. It also overcomes various technical problems in existing technologies, making it an ideal self-generating stair climber.

What is claimed is:

1. A stair climber, comprising a support frame and a generator, wherein the support frame is provided with an inclined frame, the inclined frame houses an end gear assembly, the end gear assembly is fitted with a looped chain, foldable steps are secured to the looped chain, and the end gear assembly is directly or indirectly connected to the generator; the foldable steps drive movement of the looped chain with stepping motions, thereby causing the end gear assembly to operate, and during operation, the end gear assembly drives the generator to operate.

2. The stair climber according to claim 1, further comprising a transmission pulley assembly, wherein the end gear assembly comprises two primary shafts and two gears, the two gears are spaced apart from each other, the two gears are rotatably mounted on the inclined frame via their respective primary shafts, the looped chain is sleeved on the two gears and meshes with them, and any one of the gears is drivingly connected to the generator via the transmission pulley assembly.

3. The stair climber according to claim 2, wherein the transmission pulley assembly comprises a first transmission pulley, a second transmission pulley, a third transmission pulley, a fourth transmission pulley, a fifth transmission pulley, and a sixth transmission pulley; the first transmission pulley is secured to one of the primary shafts, and a first gear on the primary shaft is coaxially arranged with the first transmission pulley; the second transmission pulley and the third transmission pulley are both rotatably mounted on the inclined frame via a secondary shaft, and the first transmission pulley is drivingly connected to the second transmission pulley via a first transmission belt; the generator is mounted on the inclined frame via a mounting frame; the fourth transmission pulley and the fifth transmission pulley are both rotatably mounted on the mounting frame via a tertiary shaft, and the third transmission pulley is drivingly connected to the fourth transmission pulley via a second transmission belt; the sixth transmission pulley is fixedly sleeved on a main shaft of the generator, and the fifth transmission pulley is drivingly connected to the sixth transmission pulley via a third transmission belt.

4. The stair climber according to claim 3, wherein a first tensioner pulley is correspondingly provided on an outer side of the second transmission belt.

5. The stair climber according to claim 4, wherein a support rod is mounted on the inclined frame, the support rod is located adjacent to the second transmission belt, a traction plate is rotatably mounted on an upper end of the support rod, a fixing rod is secured to a lower end of the support rod, a traction spring is secured to the fixing rod, an upper end of the traction spring is secured to an end of the traction plate, and the first tensioner pulley is rotatably mounted at the center of the traction plate.

6. The stair climber according to claim 5, wherein a second tensioner pulley is correspondingly provided on an outer side of the third transmission belt.

7. The stair climber according to claim 6, wherein two end gear assemblies are provided, the inclined frame is formed with a tread space and a mounting space located on opposite sides of the tread space, and the two end gear assemblies are arranged in parallel and respectively located within the respective mounting spaces; the foldable steps are located within the tread space, and two gears of each of the end gear assembly are respectively located at the top and bottom of the mounting space.

8. The stair climber according to claim 7, wherein the inclined frame comprises two spaced-apart inclined frame bodies, the tread space is formed between the two inclined frame bodies, and the mounting space is formed within the inclined frame bodies; an inclined beam is secured within each of the inclined frame bodies, and the inclined beam is arranged along the longitudinal direction of the inclined frame body; both ends of the two primary shafts are mounted on the two inclined beams via first bearing housings, respectively, and the secondary shaft is mounted on one of the inclined beams adjacent to the first transmission belt via a second bearing housing; an outer guard plate and an inner guard plate are mounted on an outer side and an inner side of each of the inclined frame bodies, respectively, each inner guard plate is formed with an elongated opening through which an inner portion of the looped chain extends, and the inner portions of each of the looped chains are respectively hinged to the opposite sides of the foldable steps.

9. The stair climber according to claim 8, wherein the two inclined beams are connected by a plurality of intermediate crossbeams, the plurality of intermediate crossbeams are located within the tread space, the foldable steps are arranged around the plurality of intermediate crossbeams, and the mounting frame is secured to one of the intermediate crossbeams.

10. The stair climber according to claim 9, wherein the foldable steps comprise a plurality of treads, the plurality of treads are arranged in a circular pattern along the looped chain and are hinged to one another, and an angle between any two adjacent treads is an obtuse angle or an acute angle.

11. The stair climber according to claim 1, wherein a power supply and a control module are provided inside the stair climber, and a driver and a pulse width modulator are provided inside the control module.

12. The stair climber according to claim 1, wherein a control panel is provided at an upper part of the stair climber, a support column is secured to the top of the inclined frame, and the control panel is secured to the support column.

13. The stair climber according to claim 1, wherein handrails are provided on sides of the stair climber, and a handle and a control panel are provided on the top of the handrail.

14. The stair climber according to claim 1, wherein the bottom of the support frame is provided with casters, and support feet are provided on the sides of the casters.

15. The stair climber according to claim 14, wherein a frame of the caster is provided with threaded holes, and a fixing column of the support foot is threadedly connected to the threaded hole.

16. The stair climber according to claim 1, wherein the generator is a variable impedance motor.
